(19) United States
(12) Patent Application Publication
(10) Pub. No.: US 2015/0035846 A1
(43) Pub. Date: Feb. 5, 2015

(54) SCANNABLE TIME-VARIED GEOMETRIC REPRESENTATION OF DATA

(71) Applicant: Alex Ioannidis, Palo Alto, CA (US)

(72) Inventor: Alex Ioannidis, Palo Alto, CA (US)

(21) Appl. No.: 13/958,132

(22) Filed: Aug. 2, 2013

(51) Int. Cl. G09G 5/02

(52) U.S. Cl. CPC G09G 5/02
USPC 345/589

(57) ABSTRACT

Exemplary methods, apparatuses, and systems display, within a portion of each of a sequence of a plurality of frames displayed on a display device, a geometric object in a first color value or hue to represent a first of a plurality of data values or in a second color value or hue to represent a second of the plurality of data values. The first color value or hue differs from the second color value or hue and the first data value differs from the second data value. Within the sequence of frames, the geometric object is displayed in each of the first and second color values or hues one or more times in a pattern corresponding to an ordered sequence of the plurality of data values, the ordered sequence of data values conveying an encoded message.

### FIELD OF THE INVENTION

The various embodiments described herein relate to a scannable time-varied representation of data. In particular, embodiments relate to encoding, displaying, detecting, and decoding a scannable set of one or more geometric objects that vary over time to represent an encoded message.

### BACKGROUND OF THE INVENTION

A one-dimensional or linear barcode represents data by varying the widths of parallel lines and, optionally, the spaces between the parallel lines. An optical scan in a single dimension detects these widths and decodes the underlying data based upon a mapping between the widths and predetermined data values. A two-dimensional or matrix barcode represents data as a grid of geometric objects of varied hues or color values. A device captures an image of the matrix barcode and decodes the underlying data based upon a mapping between hues/color values and predetermined data values.

Mobile devices, such as phones and tablets equipped with cameras and the appropriate software, are able to decode linear and matrix barcodes in printed media and displayed on electronic display devices. The greater the distance between the barcode and the mobile device, however, the larger the barcode needs to be for the mobile device to decode the barcode. Given common viewing distances of approximately six to ten feet for a television, a barcode would need to occupy a significant portion of the television screen to be decoded by a mobile device.

### SUMMARY OF THE INVENTION

Exemplary methods, apparatuses, and systems display, within a portion of each of a sequence of a plurality of frames displayed on a display device, a geometric object in a first color value or hue to represent a first of a plurality of data values or in a second color value or hue to represent a second of the plurality of data values. The first color value or hue differs from the second color value or hue and the first data value differs from the second data value. Within the sequence of frames, the geometric object is displayed in each of the first and second color values or hues one or more times in a pattern corresponding to an ordered sequence of the plurality of data values, the ordered sequence of data values conveying an encoded message. For example, every one, two, or three frames may represent a different data value in the ordered sequence.

In one embodiment, multiple geometric objects are displayed in each of the plurality of frames. For example, the geometric objects displayed in each of the plurality of frames may be arranged in a matrix of two columns and two rows. Alternatively, the plurality of geometric objects are displayed in a plurality of positions, the first geometric object in a first position representing a new data value and a second geometric object in a second position representing a data value displayed in the first position in a previous frame. In one embodiment, the pattern of color values or hues includes an encoded signal to demarcate a repetition of the encoded message.

Additional exemplary methods, apparatuses, and systems capture a sequence of images of subsequent frames displayed on a display device. A time-varied representation of data is detected within a region of a plurality of regions of the displayed frames. The time-varied representation of data includes a geometric object that varies in color value or hue over a series of subsequent frames. Color values or hues of the geometric object are identified within the series of subsequent frames. An ordered sequence of the identified color values or hues of the geometric object is determined. The ordered sequence of the identified color values or hues of the geometric object is decoded into a message comprised of data values corresponding to the varied color values or hues.

In one embodiment, detecting the time-varied representation of data includes dividing each of the images into segments and determining that one or more of the segments include display data oscillating between intensity values with greater regularity than other display data. These one or more candidate segments are selected as including at least a portion of the geometric object. For example, the selection may include summing intensity values for each candidate segment, computing a Fourier transform of the summed intensity values for the candidate segment over a period of time, and determining that the Fourier transform for the candidate segment includes intensity values above a threshold value. Intensity values in the Fourier transform above the threshold value indicate display data oscillating between intensity values with greater regularity than other display data, which is a characteristic of the regular time-varied representation of data. In another embodiment, detecting the time-varied representation of data includes using template matching to match a template geometric object to the geometric object within the displayed frames.

Other features and advantages will be apparent from the accompanying drawings and from the detailed description.

### BRIEF DESCRIPTION OF THE DRAWINGS

The present invention is illustrated by way of example and not limitation in the figures of the accompanying drawings, in which like references indicate similar elements, and in which:

FIG. 1 is a flow chart illustrating an exemplary method of displaying a scannable set of one or more geometric objects that vary over time to represent data;

FIG. 2 illustrates a display including an exemplary scannable set of one or more geometric objects and a sequence of sets of geometric objects;

FIG. 3 illustrates a display including another exemplary scannable set of one or more geometric objects and a sequence of sets of geometric objects;

FIG. 4 illustrates a display including yet another exemplary scannable set of one or more geometric objects and a sequence of sets of geometric objects;

FIG. 5 is a flow chart illustrating an exemplary method of detecting and decoding a scannable set of one or more geometric objects that vary over time;

FIG. 6 is a flow chart illustrating an exemplary method of recursively segmenting a captured image to detect a location of a scannable set of one or more geometric objects that vary over time;

FIG. 7 illustrates a captured image divided into segments for the detection of the location of the scannable set of one or more geometric objects that vary over time;

FIG. 8 illustrates a Fourier transform of the summed intensity values for each of two candidate segments over a period of time;

FIG. 9 illustrates a candidate segment further subdivided into additional segments for the detection of a location of the one or more geometric objects;

FIG. 10 illustrates, in block diagram form, an exemplary network of devices related to the encoding, displaying, detecting, and decoding a scannable set of one or more geometric objects that vary over time to represent an encoded message; and

FIG. 11 illustrates, in block diagram form, an exemplary processing system to perform encoding, displaying, detecting, or decoding of a scannable set of one or more geometric objects that vary over time to represent an encoded message.

### DETAILED DESCRIPTION

Embodiments described herein encode, display, detect, and/or decode a scannable set of one or more geometric objects that vary over time to represent data. The set of one or more geometric objects is large enough to be detected and identified at a distance while occupying a relatively small portion of a display device. By varying the color value or hue of the set of one or more geometric objects over time, a significant quantity of data values is conveyed using only the small portion of the display device. The frequency at which the color value or hue of the set of one or more geometric objects changes is more consistent than the frequency at which the color value or hue of the other video data displayed on the data device changes. A mobile device detects the geometric objects by locating a consistently changing region of the display device or performing pattern matching. The mobile device identifies the sequence of color values or hues within the series of subsequent frames and decodes the message represented by the sequence of color values or hues.

As used herein, a display device refers to a television, monitor of a processing device, a lighting grid/display (e.g., in a sports stadium), a surface receiving a projection, or another device or object on which video is displayed. As used herein, a scannable geometric object refers to an optically machine-readable object displayed on a display device. For example, a mobile device with a camera or another image sensor is able to scan a geometric object if said object is “visible” to the image sensor and detectable amongst other image data. As used herein, a color value refers to the relative lightness or darkness of a color. For example, a color value may refer to the lightness or darkness of the color blue. Additionally, a color value may refer to a point on the spectrum between black and white. As used herein, hue refers to the spectrum colors commonly referred to by name. Exemplary hues include red, orange, yellow, blue, green, violet, etc.

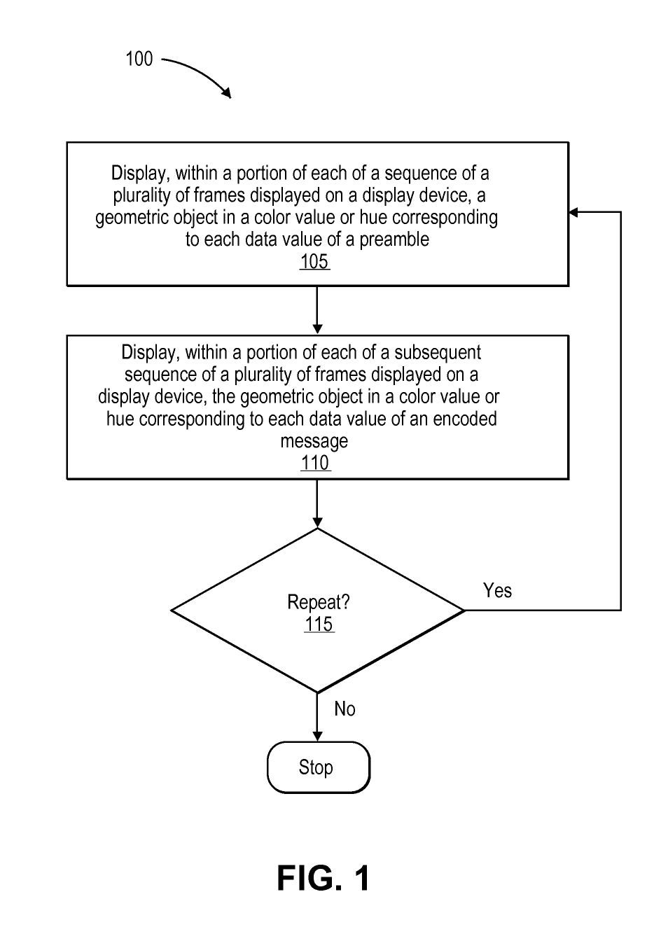

FIG. 1 is a flow chart illustrating exemplary method 100 of displaying a scannable set of one or more geometric objects that vary over time to represent a pattern of data (or otherwise causing the geometric object(s) to be displayed). At block 105, a processing device causes a display device to display, within a portion of each of a sequence of a plurality of frames, a geometric object in a color value or hue corresponding to each data value of a preamble. For example, the preamble may be a Barker code or another recognizable sequence of data values to mark the beginning of an encoded message. Additionally or alternatively, the recognizable sequence of data values follows the encoded message to mark the end of the encoded message. When an encoded message is repeated, the recognizable sequence of data values demarcates the end of a first presentation of the encoded message and the beginning of a second presentation of the encoded message.

In one embodiment, a geometric object is displayed in a color value or hue representing a single data value for one to three frames. For example, each represented data value may be displayed for two frames. Alternatively, the geometric object is displayed in a color value or hue representing a single data value for more than three frames. In one embodiment, the number of frames in which a single data value is represented is dependent upon the frame rate of the display device. For example, a display rate of 24 frames per second (fps) is lower than a video capture rate of 30 fps that may be typical of a smartphone camera. If, however, the display frame rate were higher than the video capture rate, the camera may not accurately capture changes in color value or hue each display frame. Accordingly, a higher display rate may correspond to utilizing more frames to represent a single data value. For example, geometric objects may change every x frames, where x is large enough that the display frame rate divided by x is no larger than the video capture frame rate. If a geometric object is displayed in a color value or hue representing each data value for two frames, the display rate can be at most twice the capture rate.

At block 110, the processing device causes the display device to display, within the portion of each of a subsequent plurality of frames, the geometric object in a color value or hue corresponding to each data value of an encoded message. For example, a message may be encoded according to Reed-Solomon or another type of error correction or another type of encoding. Similar to the preamble, each data value of the encoded message is displayed, e.g., for one or more frames.

At block 115, the processing device determines if the pattern of the preamble and encoded message is to be repeated. For example, the preamble and encoded message may be repeated a predetermined number of times, repeated within a predetermined amount of time, etc. If the pattern is to be repeated, method 100 continues at block 105. Otherwise, method 100 ends.

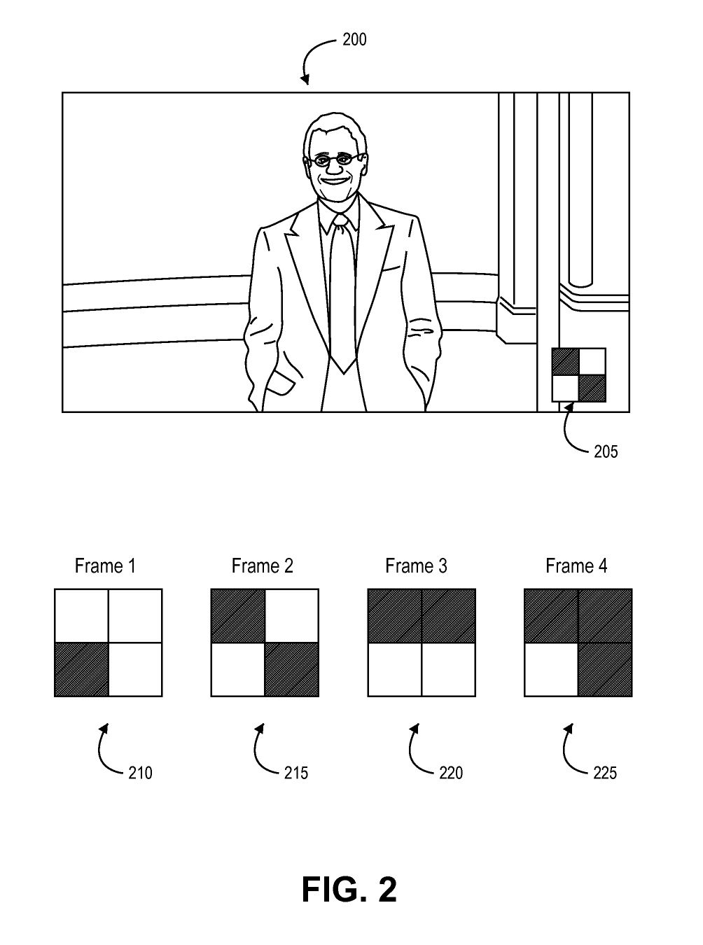

Examples of the features of method 100 will be described in additional detail with reference to FIGS. 2-4.

FIG. 2 illustrates a display 200 including an exemplary scannable set of one or more geometric objects within a portion 205 of a frame. For example, display 200 may be a television or movie broadcast/multicast, a digitally downloaded or stored video signal, or another video signal. Portion 205 of display 200 includes a scannable set of geometric objects that change in color value or hue over time. Portion 205 occupies a relatively small amount of display 200. For example, portion 205 may be less than five percent of display 200. In one embodiment, portion 205 is approximately the size of a television channel logo.

FIG. 2 further illustrates a sequence of sets of geometric objects 210-225. The illustrated sets of geometric objects 210-225 are each arranged in a matrix of two columns and two rows. While described as individual sets of geometric objects, in one embodiment, geometric objects 210-225 represent a single set of geometric objects that varies in color value over a sequence of frames. Additionally, while FIG. 2 illustrates sets of geometric objects 210-225 in two-by-two matrices, other configurations of geometric objects may be used. Each set of geometric objects 210-225 is labeled with sequential frame numbers, e.g., frame 1, frame 2, frame 3, and frame 4. In one embodiment, frames 1-4 correspond to a set of geometric objects representing a different portion of a pattern being displayed in each of four sequential frames of display 200. For example, each set of data values represented by each of geometric objects 210-225 would be displayed only for a single frame of display 200. Alternatively, each set of geometric objects 210-225 is displayed for more than one frame of display 200. For example, set 210 may be displayed for two frames of display 200, set 215 for two frames, set 220 for two frames, and set 225 for two frames. In other embodiments, each set is displayed for three, four, or more frames.

In one embodiment, each geometric object is read in a clockwise direction beginning with the top left corner. For example, set 210 may be read as white, white, white, black, set 215 may be read as black, white, black, white, set 220 may be read as black, black, white, white, and set 225 may be read as black, black, black, white. If white corresponds to a binary value of 1 and black corresponds to a binary value of 0, set 210 corresponds to 1110, set 215 corresponds to 0101, set 220 corresponds to 0011, and set 225 corresponds to 0001. Viewed together, the pattern conveyed by the changing color values of sets 210-225 is 1110 0101 0011 0001. Alternatively, geometric objects may be read in a different order or the color values may correspond to different data values.

The exemplary pattern described above includes a preamble and encoded message. For example, the first seven data values of the pattern above, 1110010, is a Barker-7 code serving as the preamble. In other embodiments, the preamble may be longer or shorter than seven data values. An eleven-bit Barker code, for example, will result in very few false positives in scanning and detecting the preamble. The remaining nine data values of the pattern above, 100110001, is at least a portion of an encoded message. The encoded message portion of the pattern may continue for additional frames. For example, ten frames of two-by-two matrices of geometric objects would convey a pattern of 40 bits of data values. If every frame of a plurality of consecutive frames of display 200 represents four bits within the pattern, and display 200 displays twenty four frames per second, the 40 bits/data values is displayed as a time-varied pattern over ten frames in less than half of a second. Likewise, if every other frame represents four bits within the pattern, the 40 bits would still be displayed in less than a second.

In one embodiment, the encoded message is comprised of a plurality of segments. For example, each segment may represent one or more alphanumerical characters, bytes, words, etc. Alphanumeric characters may be mapped to unique values that, in turn, may be converted into binary representations. In one embodiment, values for pairs of alphanumeric characters are entered into a formula to generate a single value and corresponding binary representation for the pair. For example, for a constant, C, the formula may include (C x first alphanumeric character value)+second alphanumeric character value=pair value. Such a formula may generate values for alphanumeric pairs within a range of 11 bit data values.

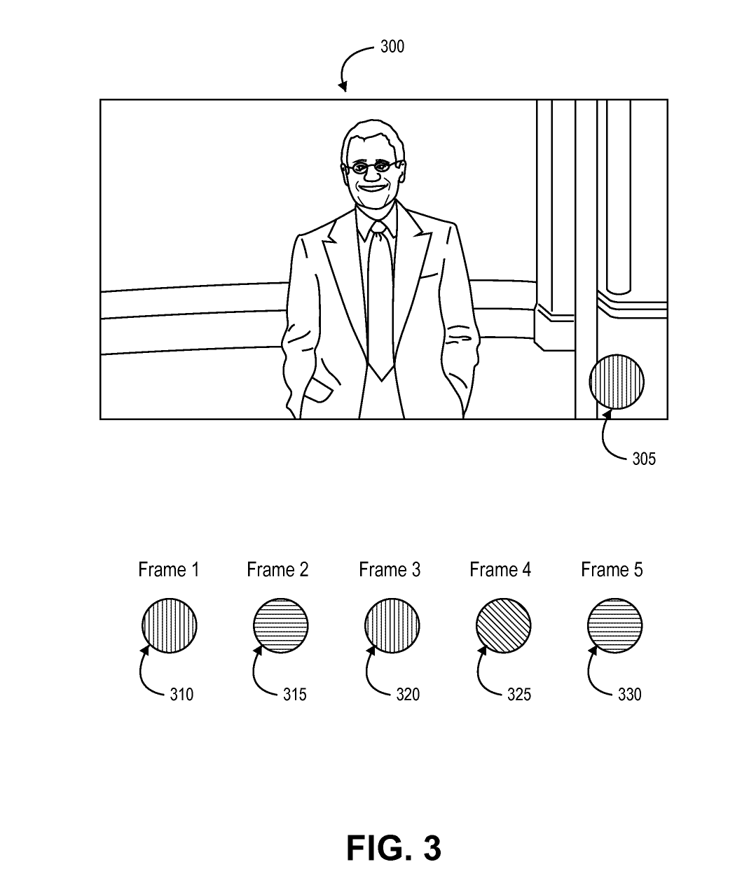

FIG. 3 illustrates a display 300 including an exemplary scannable set of one or more geometric objects within portion 305 of a frame. The displaying of scannable geometric objects is similar to the embodiments described above. In contrast to the sets 210-225 described above, however, display 300 includes a single geometric object in portion 305 of each of a plurality of frames. A single geometric object may occupy a similar amount of space within display 300 as the set of four geometric objects did in display 200 to enable easier identification of color values or hues. Alternatively, the use of a single geometric object may result in using less of display 300.

Additionally, the single geometric object included within display 300 changes in hue rather than color value. For example, the sequence of frames for the geometric object 310-330 uses red, blue, and green to represent three distinct data values. In frames 1 and 3, the geometric object 310/320 is red (as represented by the pattern of vertical lines). In frames 2 and 5, the geometric object 315/330 is blue (as represented by the pattern of horizontal lines). In frame 4, geometric object 325 is green (as represented by the pattern of angled downwards from left to right). Again, while described as individual geometric objects, in one embodiment, geometric objects 310-330 represent a single geometric object that varies in hue over a sequence of frames.

Green, red, and blue may, for example, represent the data values 0, 1, and 2, respectively. Such data values would correspond to geometric objects 310-330 representing a sequence of 12102. Alternatively, different data values may be assigned to each color. Having three possible data values enables the pattern to be encoded in base 3/trenary rather than in base 2/binary. Additional hues may be used to enable the use of additional data values. The greater number of possible hues, however, the more difficult it may be to detect a location of the geometric objects, differentiate between hues, or identify a given hue. As described above, the pattern may include a preamble and a plurality of segments, each segment representing one or more alphanumerical characters, bytes, words, etc.

While FIGS. 2 and 3 illustrate squares and circles as exemplary geometric objects, other shapes may be used. As used herein, geometric object refers to shapes bounded by straight lines, curved lines, or a combination thereof. In one embodiment, the geometric object(s) make up at least a portion of a television channel logo or another recognizable symbol.

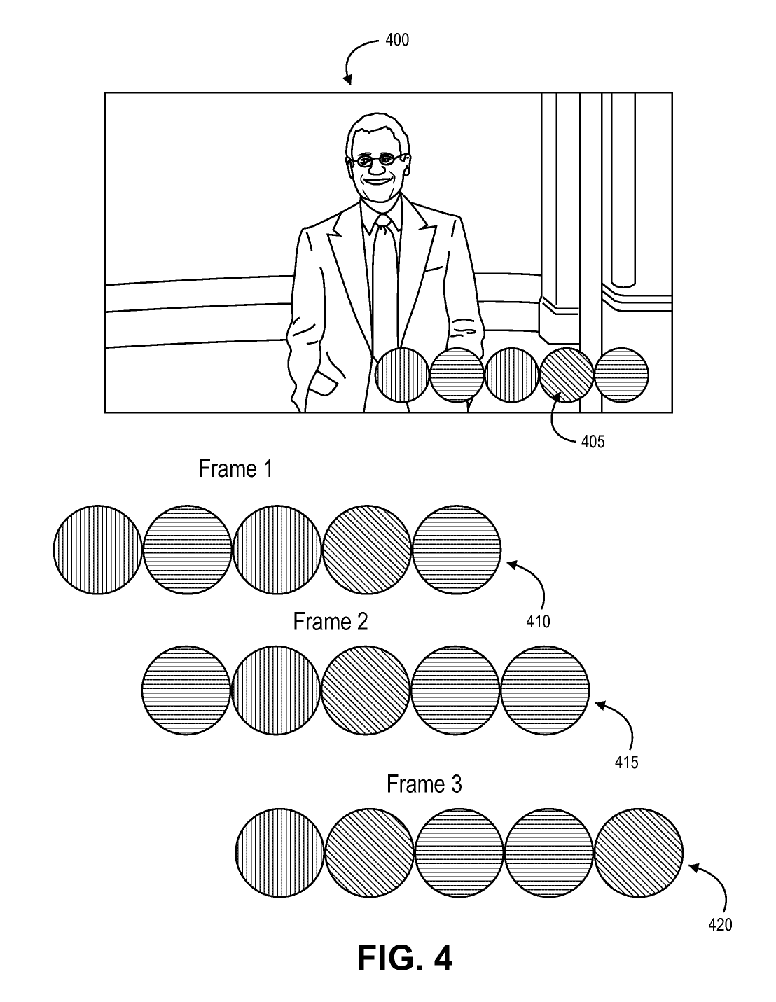

FIG. 4 illustrates display 400 including another exemplary scannable set of one or more geometric objects within portion 405 of a frame. The displaying of scannable geometric objects is similar to the embodiments described above with reference to FIG. 3. In contrast to FIG. 3, however, display 400 includes redundancy in transmission of data values. Multiple geometric objects are displayed in a line in each frame. In one embodiment, the right-most geometric object represents a new data value for a pattern while the other geometric objects represent previously displayed data values for the pattern. For example, from left to right, set 410 displays geometric objects in red, blue, red, green, and blue. The blue, right-most geometric object in set 410 represents a newly displayed data value while the red, left-most value in set 410 represents a data value displayed in previous frames. In a subsequent frame, set 415 displays geometric objects in blue, red, green, blue, and blue. The blue, right-most geometric object in set 415 represents a newly displayed data value, while the second geometric object from the right in set 415 represents the data value that was displayed in the right-most geometric object in set 410. Likewise, each data value as represented by a hue has shifted to the left one position in set 415 as compared to set 410. In other words, each geometric object takes the hue that the geometric object to the right had in the previous frame and the right-most geometric object is set to a new data value. The red, left-most value in set 410 is no longer displayed in set 415. In set 420, a new data value represented in green, is added to the right-most geometric object while the previously displayed values shift left, and so on. In an alternate embodiment, redundant values may shift in another direction. The shifting of colors across the geometric objects has the aesthetic advantage of having a rippling rainbow appearance to a user. Redundancy may also be implemented in other configurations of geometric objects, such as the two-by-two matrix described with reference to FIG. 2.

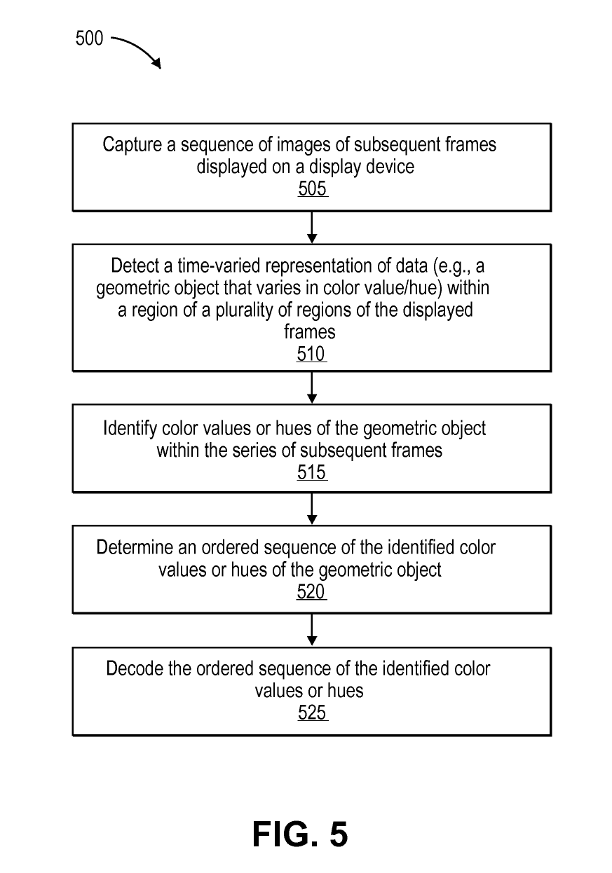

FIG. 5 is a flow chart illustrating exemplary method 500 of detecting and decoding a scannable set of one or more geometric objects that vary over time. At block 505, a processing device captures a sequence of images, e.g., using a camera coupled to the processing device or otherwise receiving images from a camera. The sequence of images is of subsequent frames displayed on a display device. The frames include one or more geometric objects that vary over time, e.g., as described above with reference to FIG. 1-4.

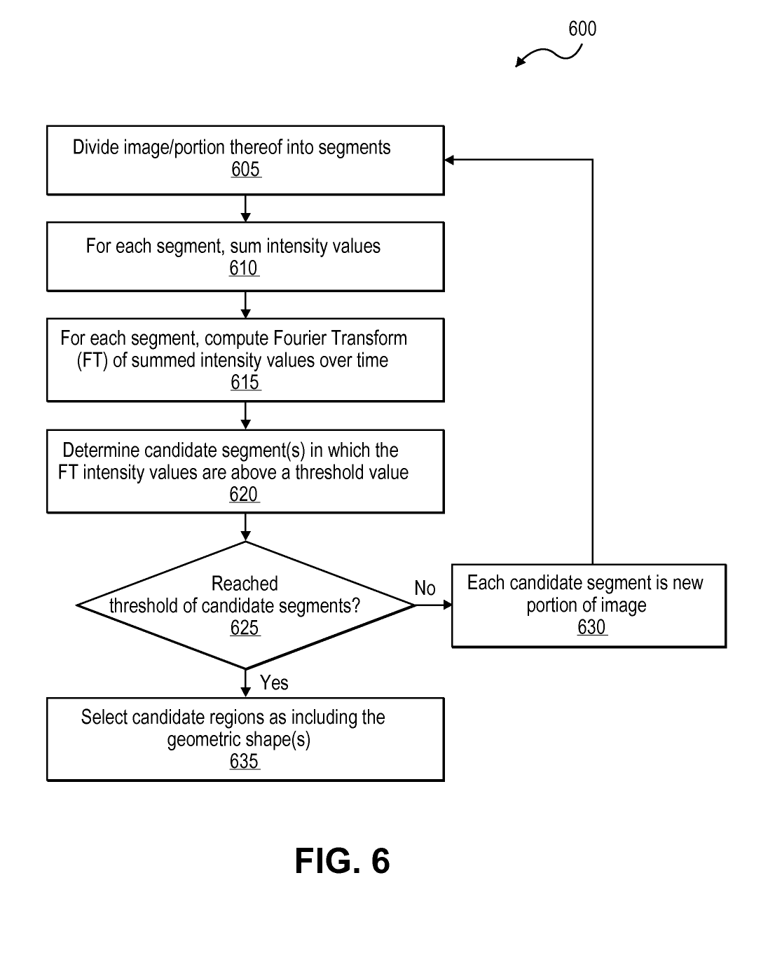

At block 510, the processing device detects a time-varied representation of data within a region of a plurality of regions of the displayed frames. The time-varied representation of data includes a geometric object that varies in color value or hue over a series of subsequent frames. In one embodiment, as described further below with reference to FIGS. 6-9, detecting the time-varied representation of data includes determining a location of the geometric object by dividing the sequence of images into segments and determining that one or more of the segments include display data oscillating between intensity values with greater regularity than other display data. Alternatively, detecting the time-varied representation of data includes using template matching to match a template geometric object to the geometric object within the displayed frames. For example, a template geometric object is compared to various portions a captured image of a displayed frame. If the geometric object is determined to sufficiently match a portion within the captured image, the processing device determines that the matching portion includes the geometric object. In yet another embodiment, the processing device detects the time-varied representation of data by determining a standard location in a display device in which geometric object(s) are included. For example, the processing device may determine a border of the display device within captured images and identify a particular portion of the captured images relative to the border.

At block 515, the processing device identifies color values or hues of the geometric object within the series of subsequent frames. For example, if data values are represented as either black or white color values, the processing device identifies a sequence of black and white color values for the geometric object. Similarly, if data values are represented as red, green, and blue color hues, the processing device identifies a sequence of red, green, and blue color hues for the geometric object. For example, the processing device may map pixel values of the geometric object to corresponding color values/hues in each captured image.

At block 520, the processing device determines an ordered sequence of the identified color values or hues of the geometric object. For example, the processing device may detect a pattern within the sequence of the varied color values or hues representing a signal to demarcate a repetition of the message. Exemplary mappings between data values and the varied color values or hues are described above with reference to FIGS. 2 and 3. In one embodiment, the pattern is a Barker code or another preamble, as described above. Using the detected pattern, the processing device determines a beginning and end to the ordered sequence.

At block 525, the processing device decodes the ordered sequence of identified color values or hues into a message comprised of data values corresponding to the varied color values or hues. For example, data values following the preamble may be the beginning of an encoded message. Again, exemplary mappings between data values and the varied color values or hues are described above with reference to FIGS. 2 and 3. In one embodiment, the decoding of the ordered sequence includes translating the ordered sequence or segments thereof into alphanumerical characters, bytes, words, etc.

FIG. 6 is a flow chart illustrating exemplary method 600 of recursively segmenting each captured image to detect a scannable set of one or more geometric objects that vary over time. At block 605, a processing device divides the image, or a portion thereof, into segments. For example, the processing device divides a captured image into two or more segments. Each image in the sequence of captured images is divided in a similar manner.

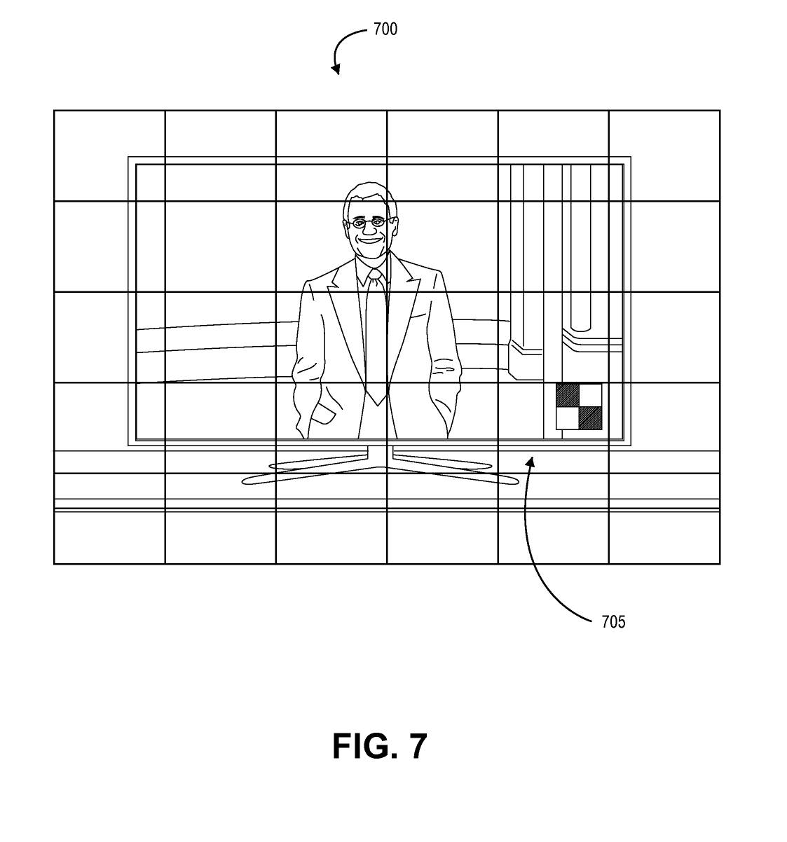

FIG. 7 illustrates captured image 700 divided into segments for the detection of a scannable set of one or more geometric objects that vary over time. Captured image 700 is divided into thirty different segments. Segment 705 includes a set of geometric objects.

Returning to FIG. 6, at block 610, the processing device sums intensity values within each segment. For example, intensity values within a segment represent the intensity values of each pixel within a segment. Intensity values may range from 0, representing black, to 1, representing white. These intensity values may represent the greyscale (monochrome) equivalents of a color display. Alternatively, if the code to be detected is a color code, red, green, and blue channel intensity values may be monitored and processed separately (as a three component vector) for the purpose of code location and analysis. The processing device sums all detected intensity values within a segment to generate a net intensity value.

At block 615, the processing device computes a Fourier transform of the summed intensity values over time. For example, given that each captured image represents a different point in time, the processing device uses a corresponding segment from each captured image to determine a time series for net intensity values within that segment. Referring again to FIG. 7, segments in a position similar to segment 705 from each of a plurality of captured images may be used to generate a time series of net intensity values.

The processing device performs a Fourier transform, e.g., using a Fast Fourier transform (FFT) or similar algorithm, on the time series of net intensity values. The result of the transform provides the intensity values over a series of frequencies. If a segment's net intensity value oscillates at a regular frequency, e.g., representing a regular oscillation between color values/hues, the transform will generate a larger intensity value at that frequency.

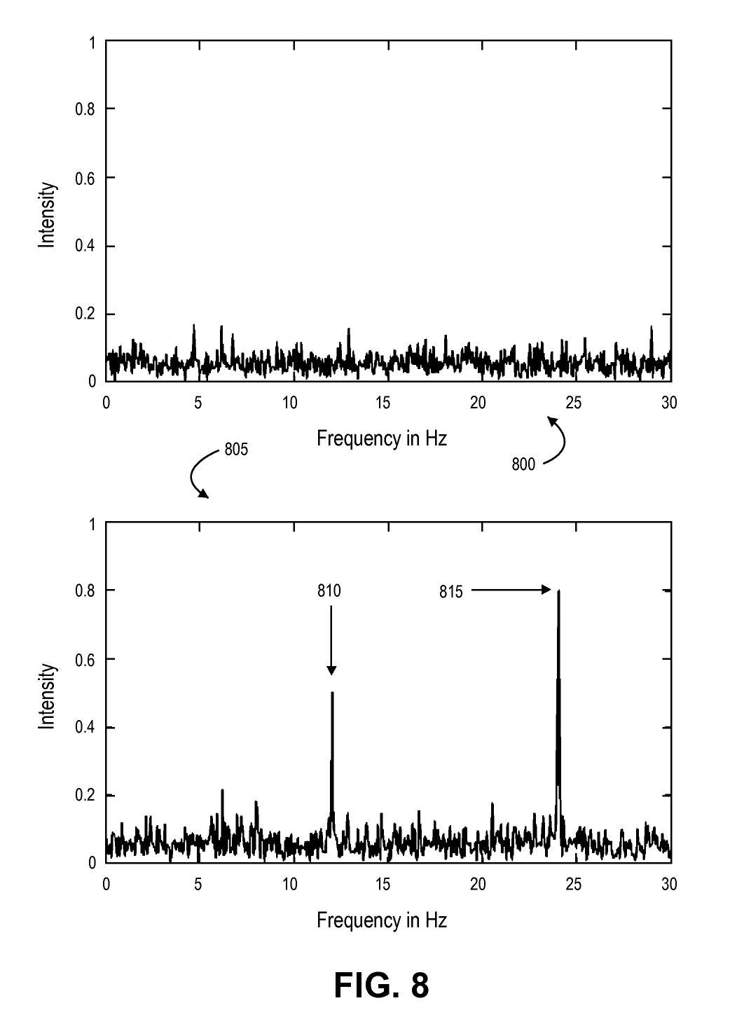

FIG. 8 illustrates a Fourier transform of the summed intensity values for each of two candidate segments over a period of time. Transform 800 represents a segment that does not include a set of one or more geometric objects that vary over time. The pixels of this representative segment vary over time to depict a portion of a video image. The pixels of this segment, however, do not oscillate between color values/hues at a frequency as regularly as they would if the segment included at least a portion of the one or more geometric objects described above. As a result, all frequencies in transform 800 maintain an intensity value between 0 and 0.2. The intensity values in transform 800 represent an exemplary noise level for transformed segments. In one embodiment, the noise level is defined by the height of the highest peaks in a transform for a segment that do not correspond to the regularly oscillating signal.

In contrast, transform 805 represents a segment that does include the one or more geometric objects, or a portion thereof. For example, transform 805 may represent a FFT of segment 705 or a similar segment including at least a portion of one or more geometric objects that oscillate between color values/hues with some regular frequency. Peaks 810 and 815 represent oscillations at approximate frequencies of 12 hertz and 24 hertz, respectively.

Returning to FIG. 6, at block 620, the processing device determines which segments are candidate segments that may (at least partially) include the one or more geometric objects. This determination includes determining which segments include Fourier transform intensity values above a threshold value. In one embodiment, the threshold value is dependent upon the noise level. For example, the threshold value may be defined as having a 1.5:1 signal to noise ratio (SNR). Accordingly, any frequencies with an intensity value that is 50% greater than the noise level would indicate the presence a regularly oscillating color value/hue of the geometric object(s). Alternatively, the threshold value may be defined based upon a different SNR or set to a constant value.

Additionally, the processing device may determine the threshold value based upon one or more of an amount of ambient light present while the images are captured, an apparent size of the electronic display in the captured images, a video capture device resolution, or color hues of the geometric object. For example, detection in the presence of high ambient light or of geometric objects utilizing color hues rather than color values may result in the processing device setting a lower threshold. A large apparent size of the geometric object(s) in the captured images (e.g., as suggested by a larger apparent size of the easily detectable electronic display) or a high resolution of the video capture device may result in the processing device setting a higher threshold.

For example, referring again to FIG. 8, if the noise level of transform 805 were determined to be approximately 0.2, and the threshold were set to 0.3, both peaks 810 and 815 would represent intensity values above the threshold value.

In one embodiment, captured images are segmented in a recursive fashion to determine the location of the geometric object(s) within the captured images. In such an embodiment, at block 625, the processing device determines if a threshold number of candidate segments/divisions has been reached. For example, the processing device may determine that the candidate regions have reached a threshold when, if subdivided again, all subdivided segments are determined to be candidate segments. Alternatively, the threshold number of candidate segments may be less than/a percentage of all segments. In another embodiment, the processing device may determine a threshold has been reached at a particular segment size. For example, the processing device may stop subdividing candidate segments when the candidate segments are the same size as the geometric object or a predetermined percentage of the size of the geometric object.

If the threshold has not been reached, at block 630, each candidate segment is treated as a portion of the image to be divided into segments and the process begins again with block 605. For example, referring to FIG. 7, segment 705 was the only segment determined to be a candidate segment. The processing device subdivides segment 705.

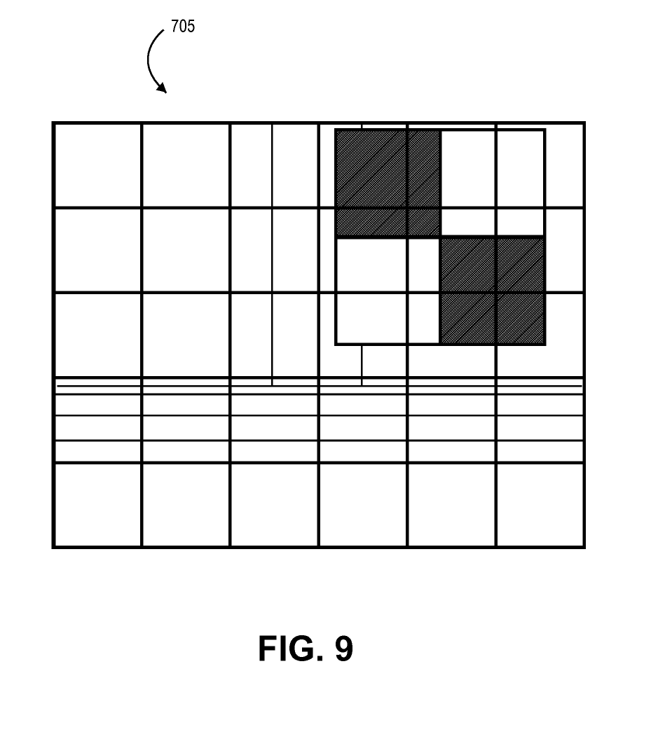

FIG. 9 illustrates candidate segment 705 further subdivided into additional segments for the detection of a scannable set of one or more geometric objects that vary over time. Similar to captured image 700, candidate segment 705 has been divided into thirty segments. Alternatively, candidate segments may be subdivided into a different number of segments than the original captured image. Repeating blocks 605-620 of FIG. 6, the processing device determines that the nine sub-segments in the upper right-hand corner of segment 705 are the new candidate segments.

Returning to FIG. 6, if the threshold has been reached, or in an embodiment that does not recursively divide the captured images, at block 635, the processing device selects the remaining candidate regions as including the set of one or more geometric objects. Once the processing device has determined the location of geometric object(s), the processing device maps pixel values to corresponding color values/hues in the determined location in each captured image, determines an ordered sequence, and decodes the ordered sequence (e.g., as described above with respect to FIG. 5).

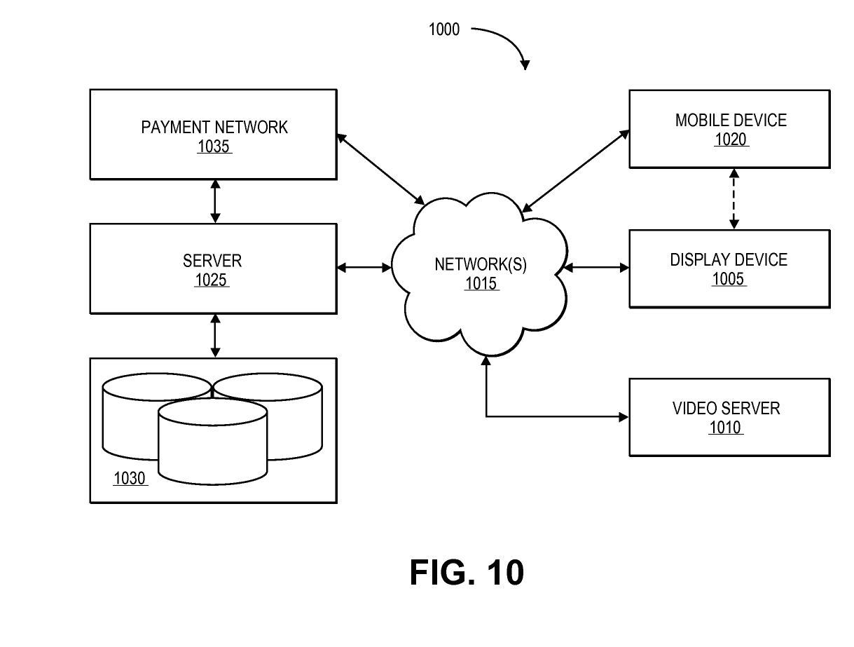

FIG. 10 illustrates, in block diagram form, an exemplary network of devices related to the encoding, displaying, detecting, and decoding a scannable set of one or more geometric objects that vary over time to represent an encoded message. For example, display device 1005 may receive a video signal from a local source (e.g., memory, a digital playback device, etc.) or from video server 1010 (e.g., a cable/satellite television provider, digital content provider on the Internet, etc.) via one or more networks 1015. As described above, the video signal transmitted by video server 1010 includes a set of one or more geometric objects that vary over time. In other words, video server 1010 causes the one or more geometric objects to be displayed on display device 1005. Mobile device 1020 uses a camera (e.g., a camera included within a smartphone, tablet, wearable computing device, etc.) to capture a sequence of images of the video signal displayed on display device 1005. Additionally, mobile device 1020 detects and decodes the encoded message as described above.

In one embodiment, the decoded message causes mobile device 1020 to transmit a request to server 1025. For example, the decoded message may cause mobile device 1020 to open a browser and navigate to a particular website. Alternatively, mobile device 1020 may transmit payment or authentication data to server 1025 and product identification data from the encoded message to facilitate the purchase of an item. In one embodiment, server 1025 retrieves or authenticates payment or other user data from database 1030 and executes payment over payment network 1035.

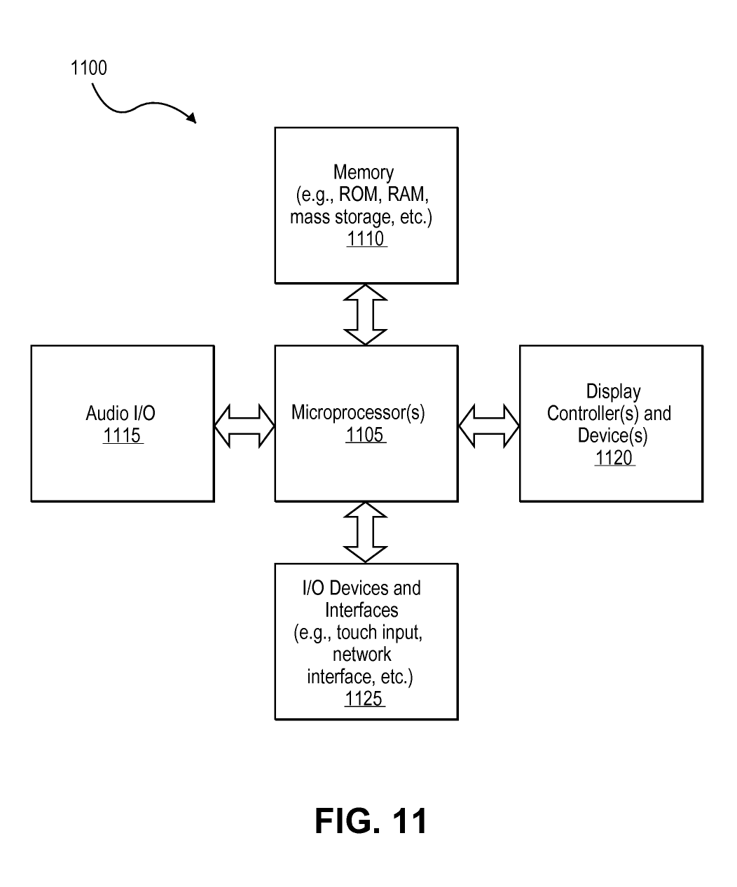

FIG. 11 illustrates, in block diagram form, exemplary processing system 1100 to perform encoding, displaying, detecting, or decoding of scannable set of one or more geometric objects that vary over time to represent an encoded message. Data processing system 1100 includes one or more microprocessors 1105 and connected system components (e.g., multiple connected chips). Alternatively, data processing system 1100 is a system on a chip.

Data processing system 1100 includes memory 1110, which is coupled to microprocessor(s) 1105. Memory 1110 may be used for storing data, metadata, and programs for execution by the microprocessor(s) 1105. Memory 1110 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1110 may be internal or distributed memory.

Data processing system 1100 also includes audio input/output subsystem 1115 which may include a microphone and/or a speaker for, for example, playing back music or other audio, receiving voice instructions to be executed by microprocessor(s) 1105, playing audio notifications, etc. Display controller and display device 1120 provide a visual user interface for the user. For example, display device 1120 may display a video signal including a set of one or more geometric objects that vary over time to represent an encoded message as described above.

Data processing system 1100 also includes one or more input or output (“I/O”) devices and interfaces 1125, which are provided to allow a user to provide input to, receive output from, and otherwise transfer data to and from the system. I/O devices 1125 may include a mouse, keypad or a keyboard, a touch panel or a multi-touch input panel, camera, optical scanner, network interface, modem, other known I/O devices or a combination of such I/O devices. For example, camera 1125 may capture images of a video signal including a set of one or more geometric objects that vary over time to represent an encoded message as described above.

I/O devices and interfaces 1125 may also include a port, connector for a dock, or a connector for a USB interface, FireWire, Thunderbolt, Ethernet, Fibre Channel, etc. to connect the system 1100 with another device, external component, or a network. Exemplary I/O devices and interfaces 1125 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect data processing system 1100 with another device, external component, or a network and receive stored instructions, data, tokens, etc.

It will be appreciated that one or more buses, may be used to interconnect the various components shown in FIG. 11.

Data processing system 1100 is an exemplary representation of one or more of display device 1005, video server 1010, mobile device 1020, and server 1025 described above. Data processing system 1100 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, data processing system 1100 may be a network computer, server, or an embedded processing device within another device or consumer electronic product. As used herein, the terms computer, device, system, processing system, processing device, and “apparatus comprising a processing device” may be used interchangeably with data processing system 1100 and include the above-listed exemplary embodiments.

It will be appreciated that additional components, not shown, may also be part of data processing system 1100, and, in certain embodiments, fewer components than that shown in FIG. 11 may also be used in data processing system 1100. It will be apparent from this description that aspects of the inventions may be embodied, at least in part, in software. That is, the computer-implemented method(s) 100, 500, and 600 may be carried out in a computer system or other data processing system 1100, e.g., in response to processor 1105 executing sequences of instructions contained in a memory, such as memory 1110 or other non-transitory machine-readable storage medium. The software may further be transmitted or received over a network (not shown) via network interface device 1125. In various embodiments, hardwired circuitry may be used in combination with the software instructions to implement the present embodiments. Thus, the techniques are not limited to any specific combination of hardware circuitry and software, or to any particular source for the instructions executed by data processing system 1100.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A computer-implemented method, comprising:
causing to be displayed, within a portion of each of a sequence of a plurality of frames displayed on a display device, a geometric object in a first color value or hue to represent a first of a plurality of data values or in a second color value or hue to represent a second of the plurality of data values,
wherein the first color value or hue differs from the second color value or hue and the first data value differs from the second data value,
wherein, within the sequence of frames, the geometric object is displayed in each of the first and second color values or hues one or more times in a pattern corresponding to an ordered sequence of the plurality of data values, and
wherein the ordered sequence of data values conveys an encoded message.

2. The computer-implemented method of claim 1, wherein the geometric object is a first of a plurality of geometric objects displayed in each of the plurality of frames.

3. The computer-implemented method of claim 2, wherein the plurality of geometric objects displayed in each of the plurality of frames is arranged in a matrix of two columns and two rows.

4. The computer-implemented method of claim 2, wherein the plurality of geometric objects are displayed in a plurality of positions, the first geometric object in a first position representing a new data value and a second geometric object in a second position representing a data value displayed in the first position in a previous frame.

5. The computer-implemented method of claim 1, wherein the pattern of the first and second color values or hues includes a signal to demarcate a repetition of the encoded message.

6. The computer-implemented method of claim 1, wherein the geometric object represents a different value in the ordered sequence of the plurality of data values every one to three frames.

7. The computer-implemented method of claim 1, further comprising:
displaying the geometric object in a third color value or hue to represent a third of the plurality of data values.

8. A non-transitory computer-readable medium storing instructions, which when executed by a processing device, cause the processing device to perform method comprising:
causing to be displayed, within a portion of each of a sequence of a plurality of frames displayed on a display device, a geometric object in a first color value or hue to represent a first of a plurality of data values or in a second color value or hue to represent a second of the plurality of data values,
wherein the first color value or hue differs from the second color value or hue and the first data value differs from the second data value,
wherein, within the sequence of frames, the geometric object is displayed in each of the first and second color values or hues one or more times in a pattern corresponding to an ordered sequence of the plurality of data values, and
wherein the ordered sequence of data values conveys an encoded message.

9. The non-transitory computer-readable medium of claim 8, wherein the geometric object is a first of a plurality of geometric objects displayed in each of the plurality of frames.

10. The non-transitory computer-readable medium of claim 9, wherein the plurality of geometric objects displayed in each of the plurality of frames is arranged in a matrix of two columns and two rows.

11. The non-transitory computer-readable medium of claim 9, wherein the plurality of geometric objects are displayed in a plurality of positions, the first geometric object in a first position representing a new data value and a second geometric object in a second position representing a data value displayed in the first position in a previous frame.

12. The non-transitory computer-readable medium of claim 8, wherein the pattern of the first and second color values or hues includes a signal to demarcate a repetition of the encoded message.

13. The non-transitory computer-readable medium of claim 8, wherein the geometric object represents a different value in the ordered sequence of the plurality of data values every one to three frames.

14. The non-transitory computer-readable medium of claim 8, further comprising:
displaying the geometric object in a third color value or hue to represent a third of the plurality of data values.

15. An apparatus comprising:
a processing device, wherein the processing device executes instructions that cause the apparatus to perform a method comprising:
causing to be displayed, within a portion of each of a sequence of a plurality of frames displayed on a display device, a geometric object in a first color value or hue to represent a first of a plurality of data values or in a second color value or hue to represent a second of the plurality of data values,
wherein the first color value or hue differs from the second color value or hue and the first data value differs from the second data value,
wherein, within the sequence of frames, the geometric object is displayed in each of the first and second color values or hues one or more times in a pattern corresponding to an ordered sequence of the plurality of data values, and
wherein the ordered sequence of data values conveys an encoded message.

16. The apparatus of claim 15, wherein the geometric object is a first of a plurality of geometric objects displayed in each of the plurality of frames.

17. The apparatus of claim 16, wherein the plurality of geometric objects displayed in each of the plurality of frames is arranged in a matrix of two columns and two rows.

18. The apparatus of claim 16, wherein the plurality of geometric objects are displayed in a plurality of positions, the first geometric object in a first position representing a new data value and a second geometric object in a second position representing a data value displayed in the first position in a previous frame.

19. The apparatus of claim 15, wherein the pattern of the first and second color values or hues includes a signal to demarcate a repetition of the encoded message.

20. The apparatus of claim 15, wherein the geometric object represents a different value in the ordered sequence of the plurality of data values every one to three frames.
